(19) United States
(12) Patent Application Publication
(10) Pub. No.: US 2008/0314256 A1
(43) Pub. Date: Dec. 25, 2008

(54) FILTER HANDLING APPARATUS

(75) Inventor: Rodney P. Smith, Moline, IL (US)

Correspondence Address: WOOD, HERRON & EVANS, LLP, 2700 CAREW TOWER, 441 VINE STREET, CINCINNATI, OH, 45202, US

(73) Assignee: PACKAGING TECHNOLOGIES, INC., Davenport, IA (US)

(21) Appl. No.: 11/766,369

(22) Filed: Jun. 21, 2007

(51) Int. Cl. A47J 31/06

(52) U.S. Cl. 99/298

(57) ABSTRACT

An apparatus and method for precisely placing a beverage brewing filter into a beverage brew cup. Air pressure and velocity are used to overcome variations in the filter or environment. A hard stop and a filter catch are used to catch a filter at a first position, and to shuttle the filter to a second position to be placed in a brew cup. A shoulder may be provided in the catch to prevent rebound.

### FIELD OF THE INVENTION

This invention relates to the preparation of brewing cups with filters and beverage media for use in brewing equipment such as beverage vending machines.

### BACKGROUND OF THE INVENTION

In the past, brewing cups are divided into two chambers by an intermediate filter typically sealed to the cup rim along with a pierceable top or cover. A beverage medium such as coffee is supported by the filter. In use, a hot water tube pierces the top and directs hot water under pressure into the coffee medium. This percolates through the coffee medium and hot coffee beverage passes through the filter into the cup chamber thereunder for dispensing, perhaps through a discharge tube piercing the chamber bottom.

Manufacture of such brewing cups with filters presents several continuing difficulties. For example, it is desired to place the filters into the cups precisely. Misaligned or misplaced filters may cause sealing aberrations or other brewing and delivery problems.

Current processes include blowing the filters into cups with air pressure. Seating depth is adjusted by adjustment of the air velocity.

Changes in this filter forming and transfer process create problems with repeatability in filter placement depth and with filters turning in the cups. Even if a dedicated filter seating station is employed, past apparatus does not adequately compensate for original filter placement errors in the cup transfer process. In some cases, the filter will turn or misform as it enters the cup due to the low filter delivery velocity as required for direct filter placement in the cup. Such low velocity is necessary because use of higher velocities may cause rebound or other anomalies adversely affecting the precise position of the filter in the cup.

Changes in the filter media, due to changes in the ambient temperature, ambient humidity, the filter media material and/or in the former process cause small changes in the filter or in its response to the delivery force. These small changes can adversely affect filter delivery velocity and filter placement in the cup.

It has thus been one objective of the invention to provide improved apparatus and methods for precisely and repeatedly transferring a filter into a brew cup.

Another objective of the invention has been to provide apparatus and methods for accurately transferring and placing filters in brewing cups at consistent seating depths and without turning or misforming filters.

A further objective of the invention has been to provide improved apparatus and methods for accurate filter seating in brew cups while tolerating variations in the filter transfer process.

A further objective of the invention has been to provide improved apparatus and process for transferring filters with adjustment for variations in filter shape, mass and stiffness.

### SUMMARY OF THE INVENTION

To these ends, one embodiment of the invention contemplates delivering a filter at a high velocity to a precise position defined by a hard stop, precisely positioning the filter and thereafter transferring the filter to the cup in a more precise, repeated manner than can be achieved by current air flow delivery techniques. More particularly, one embodiment of the invention comprises apparatus for pre-staging a filter at a first position by capturing an air-fed filter in a catch or receiving chamber, then at a second position, inserting the pre-staged filter into final position in a cup via a mechanical filter pusher. This is accomplished in one embodiment by driving a filter against a precise, hard stop associated with the chamber. The filter, driven by air at a relatively high velocity, is captured in the bottomless chamber of the catch. The catch is then moved to a second position where a ram is controlled to positively drive the filter from the chamber into a cup at the second position. The filter catch is disposed over a fixed shuttle plate having a precise stop surface for stopping the filter to catch it precisely in the chamber. Air passages or apertures are provided through the hard stop surface to allow the passage or release of air as the filter is transferred into the chamber above the stop surface. Moreover, an anti-rebound shoulder may be provided to engage an upper edge of the filter once it passes the shoulder as the filter is driven to the stop. The filter catch and chamber are then moved along the shuttle plate to a loading aperture at a second station in the shuttle plate where the filter and the loading aperture are disposed over a filter receiving cup beneath the second position A ram is precisely controlled to push the filter from the chamber of the filter catch through the loading aperture and into the cup to a predetermined position therein, which can be its final position or a staged position prior to final positioning by that or another ram or by other suitable means.

Filters are fed to the filter catch through a filter tube by air differential controllable to adjust filter feed velocity for positively driving the filter to a filter stop such as the shuttle plate stop surface. Preferably, the differential is selected to produce a velocity sufficient to overcome any changes in the parameters of the process or filter that may prevent filter placement in the catch within a range from which the filter can be precisely positioned in a brewing cup.

The filter catch can be mechanically reciprocated between the first and second positions or driven pneumatically, hydraulically, electrically or by other suitable means.

Accordingly, a filter is positively controlled through feeding to precise staging or final placement in the cup. Changes in the filter are accommodated by a controllable air supply for positively driving the filters in the tube to a precise hard stop. An optional inwardly directed one-way rebound shoulder may be used, where desired, in the receiving chamber to prevent filter rebound from the chamber after the filter engages the hard stop. Air passages through the hard stop surface facilitate filter transfer into the chamber. Precise filter placement in the chamber is consistently repeatable. There is only slight, if any, turning or misforming of the filter through the entire feed and insertion process. Moreover, changes in filter media due to ambient temperature changes, ambient humidity changes, filter media material or the former process are overcome, resulting in eventual precise filter placement in the cup.

Thus the provision according to the invention of relatively higher pressure differentials delivering higher filter delivery velocities into the intermediate transfer chamber or catch results in overcoming small variations in delivery force, filter velocity, and filter parameters, and prevents these variations from adversely affecting filter position where it is most critical.

It will be appreciated that the filter-receiving cups are transferred to a position adjacent the fixed shuttle plate, by a conveyor or any other suitable means, where they may be oriented to receive filters from the catch. Single, dual or other plural cup lines can be provided with associated multiple or ganged catches.

Finally, it will be appreciated that in an alternate embodiment, the filter placement ram is eliminated and filters could be picked from the catch and placed into a cup by any suitable pick and place mechanism or expedient, rather than being pushed into a cup by a ram.

These and other features and advantages of the invention will become even more readily apparent from the following detailed description of preferred and alternative embodiments and from the drawings:

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is an elevational view in partial cross-section illustrating a filter handling apparatus according to the invention showing a filter former connected to the filter handling apparatus via a pneumatic feed tube, and a source of controlled pneumatic pressure differential;

FIG. 2 is an elevational view in partial cross-section of the filter handling apparatus of FIG. 1 illustrating a filter catch at a first position and final filter placement into a cup at another position.

FIG. 3 is an enlarged cross-sectional view of a portion of a filter catch of the invention of FIGS. 1 and 2 omitting a filter inside the catch for clarity and showing the catch in the second position.

### DETAILED DESCRIPTION

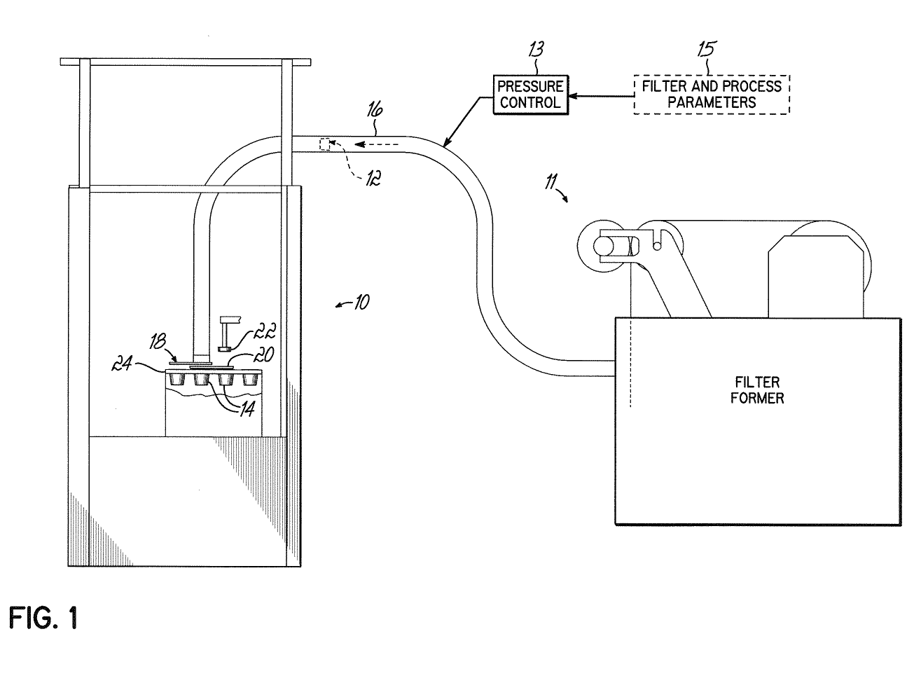

Turning now to the drawings, FIG. 1 illustrates a filter placement apparatus 10 according to one embodiment of the invention generally comprising a feed tube 16 carrying filters 12 from a filter former 11. Filters 12 are preferably, but not necessarily, fluted filters of commonly known type of construction as used in filtering beverage media such as coffee or powdered concentrations or the like. The details of filter former 11 are not part of the present invention. It is illustrated for clarity, showing but one of a number of ways formed filters can be introduced to feed tube 16.

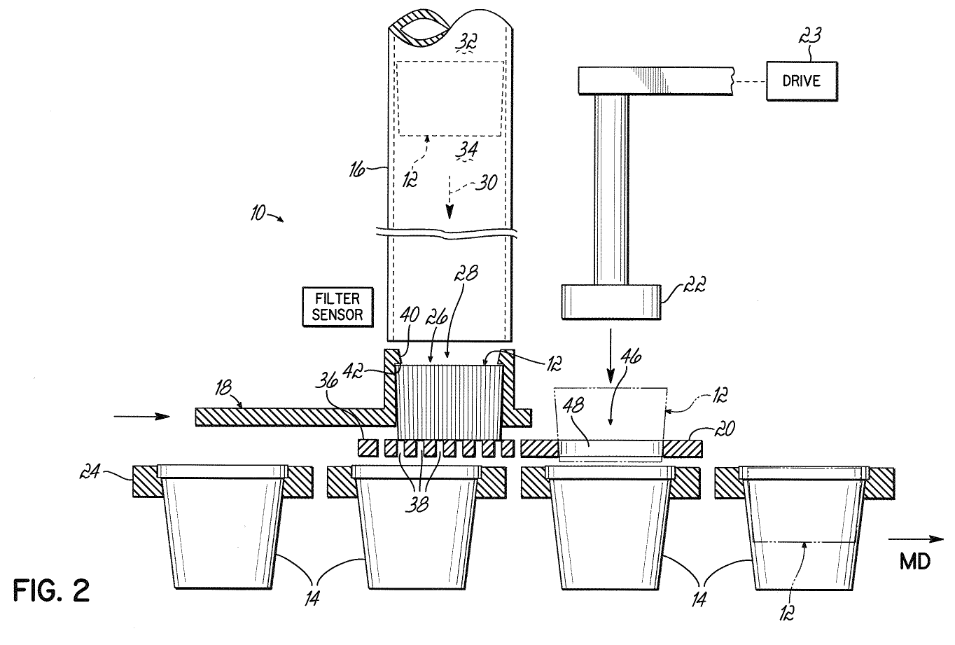

A pressure controller 13 controls the supply of air pressure to create a pressure differential that transfers filters through tube 16. The controller 13 is adjustable manually, or optionally, it can be sent feedback on predetermined parameters 15 of certain filter characteristics or the environment, including, but not limited to size, weight, porosity, humidity, and accuracy of the actual placement positions obtained. Any suitable form of programmable controller and parameter input devices can be used. Now with reference to details of the invention, tube 16 is positioned over a reciprocal filter catch 18 defined in part by a filter receiving chamber 26. The filter catch 18 is positioned over a fixed shuttle plate 20, which extends from a first filter receiving position 28 (FIG. 2) to a second filter discharge position 46 underneath a pusher 22 driven by a suitable drive 23. Catch 18 is reciprocally driven between these two positions.

Cups 14 are sequentially transferred under the fixed shuttle plate 20, in alignment with pusher 22 for receiving filters 12. In this embodiment, cup 14 is shown as one of many cups in conveyor 24 moving in a machine direction MD (FIG. 2). It can be appreciated that the filters and the cups can be brought into the apparatus by any suitable means, and they do not need to be aligned with each other except when brought together at the second position 46 where pusher 22 is located.

It will also be appreciated that FIG. 2 illustrates an apparatus for placing one filter 12 into one cup 14 at a time. The apparatus may, however, include a plurality of all components as described, or a plurality of only some components acting together or a ganged construction to fill with filters all the cups presented. For example, the apparatus could be configured with 4 tubes, 4 catches, 4 shuttle plates and 4 pushers, or the catch and shuttle could be constructed as larger units, capable of simultaneously performing all 4 placements. Similar arrangements and timing changes can be made with one or more pushers, acting either simultaneously or in sequence. Accordingly, the various features of the invention may be used alone or in numerous combinations depending on the needs and preferences of the user, without departing from the spirit or scope of the invention.

FIG. 2 illustrates an embodiment in which filters travel through a feed tube 16 into receiving chamber 26 of filter catch 18 while the catch is located at first filter receiving position 28 directly under the feed tube 16. The filter 12 is propelled in the direction 30 by the flow of air resulting from a higher pressure of air on the upstream side 32 of the filter relative to the downstream side 34. The supply pressure is created and controlled by a variety of suitable means well known in the art, as either a pressure system or a vacuum system, and it can be adjusted based on feedback or inputs indicative of predetermined parameters of certain filter characteristics if desired. This adjustment, using devices well known in the art, can be performed manually or automatically based on feedback from speed sensors or some other characteristic of the filter or of the system performance.

In any event, the filter 12 is transferred at sufficient velocity to drive it against the hard stop surface 36 of the fixed shuttle plate 20. The stop surface 36 has vent openings 38 to allow the air ahead of the moving filter 12 to escape without slowing its travel.

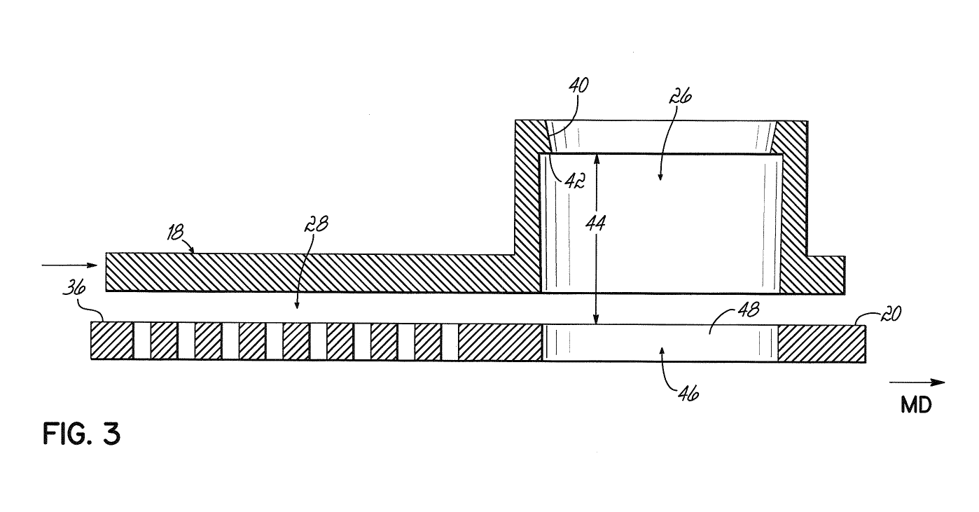

In one embodiment, anti-rebound one-way shoulders 42 are defined in catch 18, extending into chamber 26. The receiving chamber 26 may thus be provided with a circular or segmented inwardly directed wall 40 creating at least one shoulder 42. The shape of this shoulder 42 allows the filter 12 to pass one-way in direction 30 but prevents the filter 12 from rebounding upstream in a direction opposite direction 30. The height 44 (FIG. 3) of the shoulder 42 above the stop surface 36 is controlled to minimize the filter's rebound without applying a downward force to the filter 12 once the filter 12 has stopped moving.

Such shoulder is optional. It will be appreciated that the transfer pressures and filter velocity may be controlled so that filters are positively positioned in the chamber without use of the shoulder 42, with any variations easily accommodated by the use of the ram, finally placing the filters to accurate repeated depth in the brewing cups.

Thus the filter can be driven against stop surface 36 with such velocity as to overcome variables in the filter without regard to rebound, or where the shoulder 42 is not used, with only insignificant rebound. This invention, by providing a hard fixed stop 36 and relatively high filter delivery forces and velocities at the end of the air transfer, prevents small variations from adversely affecting the resting position of the filter. The ability to move the filter at a high speed into a solid stop with controlled rebound make this operation less sensitive to filter variation than the previous filter delivery methods referred to above.

After a filter 12 is fed to catch 18 and retained, the filter catch 18 moves the filter 12 by sliding it lightly over the shuttle plate 20 from first receiving position 28 to a second or discharge position 46. Position 46 is centered over a loading aperture 48 in the fixed shuttle plate 20, and is preferably centered under pusher 22 and over a cup 14. While the filter catch 18 dwells at second position 46, the filter pusher 22 performs a stroke to push the filter 12 from chamber 26 through and clear of the loading aperture 48 and into the cup 14 to a precise depth, repeatable from filter to filter. The pusher 22 retracts, leaving the filter 12 in the cup 14. The filter catch 18 then reciprocates or returns to first position 28 for receiving a subsequent filter. The cup conveyor 24 indexes or other suitable movement takes place to move the now combined filter 12 and cup 14 combination to its next station, while moving another cup 14 into position for the next cycle of the apparatus.

It will be appreciated that filters such as filter 12 are sequentially introduced to catch 18 that receives the filter, pre-stages it and shifts it laterally from a first position 28 to a second discharge position 46 where the filter is pushed into a cup 14. It will be further appreciated that other devices such as a pick and place device rather than a pusher and an aperture may be used to transfer the filter from the filter catch to the precise position and depth in the cup.

One skilled in the art may realize that a lightweight object such as the filter 12 may tend to cling to the pusher, and that if it does so it will not necessarily stay in the cup at the required precise depth. In this regard, apparatus for clamping, stripping, or interlocking the filter 12 to cup 14 such as a weld can be used. It may also be achieved by immediately adhesively bonding the filter to the cup.

These and other modifications and advantages will be readily appreciated without departing from the scope of the invention and applicant intends to be bound only by claims appended hereto.

What is claimed is:

1. A beverage filter transfer apparatus comprising:
a filter catch for receiving a beverage filter at a first position;
said filter catch being movable to present said filter to a second position, and
a ram operable for setting said filter from said filter catch into a brewing cup proximate said second position.

2. Apparatus as in claim 1 including a filter feed tube oriented to present said beverage filter to said filter catch at said first position.

3. Apparatus as in claim 2 including means for establishing an air pressure differential in said filter feed tube for transferring said filter through said tube into said filter catch.

4. Apparatus as in claim 3 including means to control said differential and said means being dependent upon the parameters of a filter to be transferred through said filter feed tube to said filter catch.

5. Apparatus as in claim 1 wherein said filter catch comprises a filter receiving chamber having an inwardly directed shoulder at an upper end thereof for capturing said filter in said chamber.

6. Apparatus as in claim 5 further including a fixed shuttle plate disposed beneath said chamber, said shuttle plate defining a stop surface beneath said chamber proximate said first position.

7. Apparatus as in claim 6 wherein said fixed shuttle plate comprises a loading aperture operationally oriented with respect to said second position and of sufficient cross-sectional area to allow passage of a filter therethrough when said filter catch is located at said second position.

8. Apparatus as in claim 7 wherein said filter receiving chamber, when in the second position, orients said filter in operative alignment with said loading aperture and said ram.

9. Apparatus as in claim 6 wherein said shuttle plate stop surface has an air passage therethrough.

10. Apparatus as in claim 9 wherein said filter catch is movable along said fixed shuttle plate from said first position wherein said chamber is in position to receive a filter, to said second position wherein said chamber is aligned with said ram.

11. Apparatus as in claim 1 wherein the filter catch is mounted for reciprocal movement between said first and second positions.

12. Apparatus as in claim 1 including a filter tube for transferring a filter to said filter catch and means to supply air to said tube to move a filter therethrough.

13. Apparatus as in claim 12 including means for controlling the velocity of a filter in said tube.

14. Apparatus as in claim 13 wherein said velocity is controlled at a level sufficient to overcome filter variations resisting accurate filter placement within said catch.

15. In a filter handling apparatus, a filter catch comprising;
a hard stop surface for stopping a moving filter in a predetermined position and a rebound shoulder for preventing rebound of said filter from said predetermined position.

16. A method for transferring a filter from a filter former to a brewing cup, said method comprising;
moving the filter to a first position in a filter catch where the bottom of the filter is against a hard stop; and
transferring the filter away from the hard stop to a second position adjacent said brewing cup.

17. The method of claim 16 further comprising capturing the filter in said filter catch between said hard stop and a shoulder in the filter catch.

18. The method of claim 16 further comprising moving the filter to said second position adjacent the brewing cup and from there transferring the filter to a brewing cup.

19. The method of claim 18 wherein the second position is aligned with the brew cup and the method further comprises pushing the filter from the second position into the brewing cup.

20. The method of claim 19 wherein the second position is defined in part by an aperture through which the filter passes when being pushed into the brew cup, and including the step of pushing the filter through said aperture.

21. The method of claim 17 including pushing said filter from said filter catch and placing the filter into a brewing cup to a predetermined depth.

22. The method of claim 16 including the step of moving the filter to the first position by air pressure differentials on respective portions of the filter.

23. The method of claim 22 including pushing air forward of said filter through said hard stop.

24. The method of claim 22 including controlling said pressure differential at a level to transfer a filter between said stop and a shoulder in said catch.

25. A method of transferring a filter into a cup comprising the steps of:
transferring a filter into a filter catch;
capturing the filter in the catch; and
thereafter transferring the filter into a cup.

26. A method as in claim 25 wherein transferring a filter into a filter catch includes blowing said filter into said catch.
